(19) United States
(12) Patent Application Publication
(10) Pub. No.: US 2006/0290280 A1
(43) Pub. Date: Dec. 28, 2006

(54) Cold cathode fluorescent lamp and electrode thereof

(75) Inventors: Kuang-Lung Tsai, Taoyuan Hsien (TW); Ruey-Feng Jean, Taoyuan Hsien (TW); Shih-Hsien Lin, Taoyuan Hsien (TW)

Correspondence Address: BIRCH STEWART KOLASCH & BIRCH, PO BOX 747, FALLS CHURCH, VA, 22040-0747, US

(73) Assignee: DELTA ELECTRONICS, INC.

(21) Appl. No.: 11/453,042

(22) Filed: Jun. 15, 2006

(30) Foreign Application Priority Data
Jun. 27, 2005 (TW) 094121369

(51) Int. Cl. H01J 61/04; H01J 17/04

(52) U.S. Cl. 313/631

(57) ABSTRACT

An electrode for a cold cathode fluorescent lamp comprises an electron emission layer and an anti-collision layer. In this case, the anti-collision layer covers at least one portion of an outer surface of the electron emission layer and is made of an anti-collision material. The anti-collision material is ceramic, titanium, niobium, molybdenum, or alloy thereof.

### BACKGROUND OF THE INVENTION

1. Field of Invention

The invention relates to an electrode structure and, in particular, to an electrode structure of a cold cathode fluorescent lamp.

2. Related Art

Non-self-emissive displays, e.g. liquid crystal displays, usually equip with a backlight module, which is generally provided as a light source at the rear side of the display screen, to generate image. At present, a clod cathode florescent lamp is commonly used as the light source of the backlight module.

With reference to FIG. 1, the conventional cold cathode florescent lamp 10 includes a sealed tube 101 filled with a mixture rare gas and mercury vapor and having a florescent layer 102 coated on its inner surface. Each of electrodes 103 is embedded into each end of the sealed tube 101. A lead 11 coupling to each electrode 103 passes through the sealed tube 101 and then connects to a high voltage power supply. The high voltage power supply drives the electrodes 103 to emit electrons in a high electric field, and then the emitted electrons collide with the rare gas and the mercury vapor in the sealed tube 101 for further generating ultraviolet rays. After that, the ultraviolet rays excite the fluorescent layer 102 on the inner surface of the sealed tube 101 to emit visible light eventually.

With respect to the various liquid crystal displays, the clod cathode florescent lamp 10 is trending towards smaller, thinner diameter, higher luminance, and longer lifetime. To obtain the higher luminance and longer lifetime, increasing voltage is a possible way to enable the clod cathode florescent lamp 10 to emit intense light. However, the high power consumption caused by the increased voltage usually results in the limited operating time of the lamp. Additionally, at the discharge procedures, the materials of the electrodes 103 are bombarded by the ions and then sputtered on the inner surface of the sealed tube 101. This will short the lifetime of the clod cathode florescent lamp 10 after a long period of usage.

At present, for reducing the threshold voltage, the electrodes 103 of the cold cathode florescent lamp 10 are usually made of materials with a small work function value such as nickel, molybdenum, niobium, and the likes. Moreover, because the work function values of molybdenum and niobium are smaller than the work function value of nickel, molybdenum and niobium have lower threshold voltage and better ion-bombardment endurance, and their costs are also higher. With reference to FIG. 2, in order to satisfy the lower cost and lower threshold voltage requirements, the electrode 103 having double conductive layers is disclosed. The inner layer 103a of the electrode 103 is made of the material with lower threshold voltage such as molybdenum or niobium, and the outer layer 103b thereof is made of the material of lower cost such as nickel. As a result, the manufacturing cost of the electrode 103 can be effectively reduced.

However, due to the work function value of the outer layer 103b of the electrode 103 is larger than the work function value of the inner layer 103a thereof, the electrode 103 exposed to the discharge field for a long time usually produces excessive sputtered materials. The sputtered material will consume huge amount of mercury vapor, so that the useful lifetime of the cold cathode florescent lamp 10 is interfered.

Therefore, it is an important subject of the invention to provide a cold cathode fluorescent lamp and an electrode thereof having lower threshold voltage and less mercury vapor consumption for increasing the lifetime of the cold cathode fluorescent lamp.

### SUMMARY OF THE INVENTION

In view of the foregoing, the invention is to provide a cold cathode fluorescent lamp and an electrode thereof having lower threshold voltage, less mercury vapor consumption and longer lifetime.

To achieve the above, an electrode for a cold cathode fluorescent lamp of the invention includes an electron emission layer and an anti-collision layer. In the invention, the anti-collision layer covers at least one portion of an outer surface of the electron emission layer and is made of an anti-collision material.

Additionally, the electrode for a cold cathode fluorescent lamp of the invention further includes an conduction layer disposed between the electron emission layer and the anti-collision layer. Herein, a work function value of the conduction layer is larger than a work function value of the electron emission layer.

To achieve the above, a cold cathode fluorescent lamp of the invention includes a housing and at least one electrode. In the invention, the electrode sets at an end of the housing and includes an electron emission layer and an anti-collision layer. The anti-collision layer covers at least one portion of an outer surface of the electron emission layer and is made of an anti-collision material.

Additionally, the electrode of the cold cathode fluorescent lamp further includes an conduction layer disposed between the electron emission layer and the anti-collision layer. Herein, a work function value of the conduction layer is larger than a work function value of the electron emission layer.

As mentioned above, a cold cathode fluorescent lamp and an electrode thereof of the invention utilize an conduction layer, i.e. the anti-collision layer, to cover at least one portion of an outer surface of another conduction layer, i.e. the electron emission layer, which primarily emits electrons. In the invention, the electron emission layer can be made of materials with a small work function value for reducing the threshold voltage. In addition, the anti-collision layer is made of an anti-collision material. Compared with the prior art, the cold cathode fluorescent lamp of the invention can significantly prevent the electrode from being sputtered and reduce the mercury vapor consumption. Thus, the lifetime of the cold cathode florescent lamp is increased. Moreover, since the electrode is partially composed of the conduction layer with the high work function value, the manufacturing cost of the electrode of the invention is less than that of the conventional electrode made of the conduction layer with low work function value only.

### BRIEF DESCRIPTION OF THE DRAWINGS

The invention will become more fully understood from the detailed description given herein below illustration only, and thus is not limitative of the present invention, and wherein:

FIG. 1 is a schematic view showing the conventional cold cathode florescent lamp;

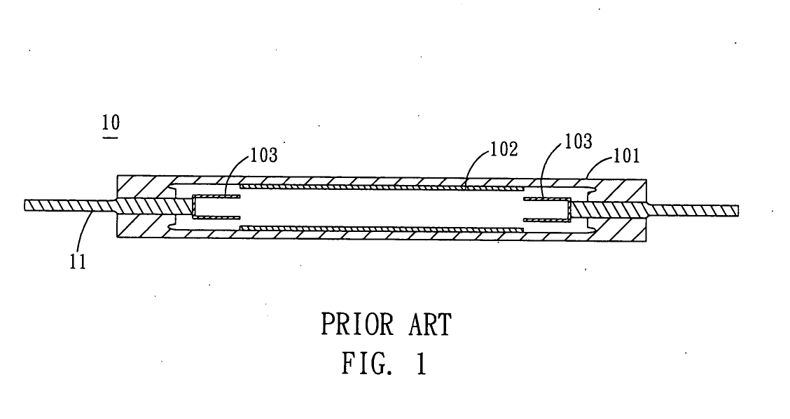

FIG. 2 is a schematic view showing the conventional electrode of the cold cathode florescent lamp;

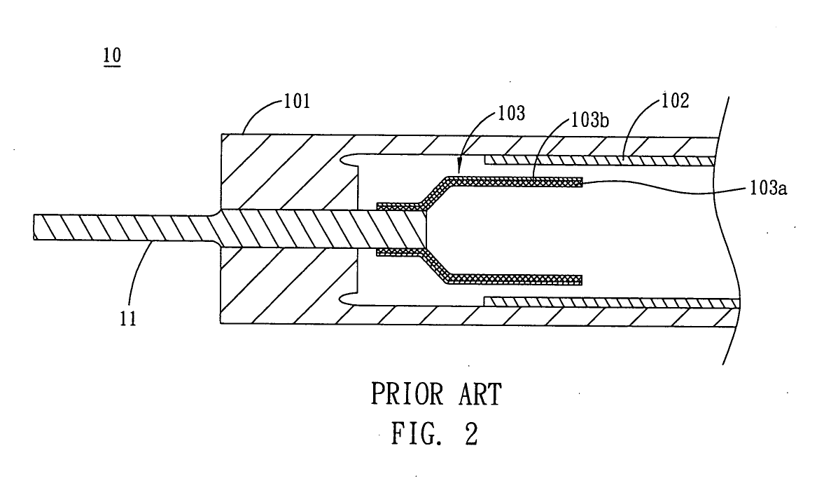

FIG. 3 is a schematic view showing a cold cathode florescent lamp and an electrode thereof according to a preferred embodiment of the invention;

FIG. 4 is a schematic view showing another electrode according to the preferred embodiment of the invention;

FIG. 5 is a schematic view showing still another electrode according to the preferred embodiment of the invention; and

FIG. 6 is a schematic view showing yet another electrode according to the preferred embodiment of the invention.

### DETAILED DESCRIPTION OF THE INVENTION

The present invention will be apparent from the following detailed description, which proceeds with reference to the accompanying drawings, wherein the same references relate to the same elements.

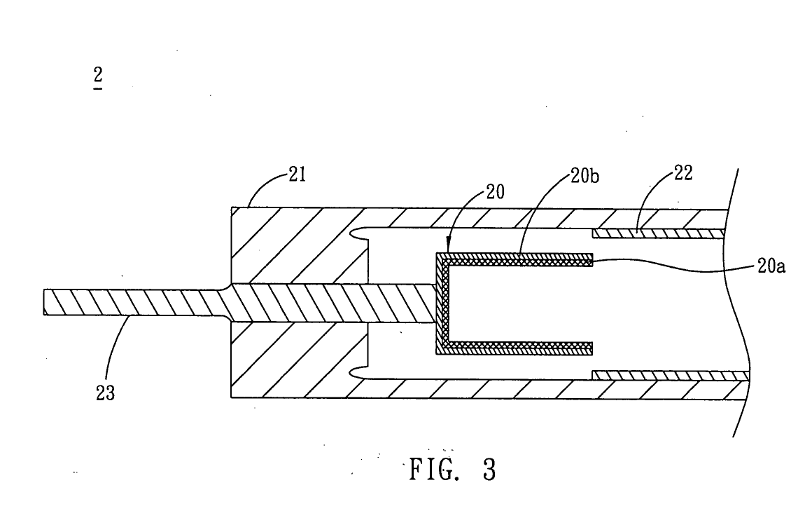

With reference to FIG. 3, an electrode 20 according to a preferred embodiment of the invention includes an electron emission layer 20a and an anti-collision layer 20b. The electrode 20 is used for a cold cathode fluorescent lamp 2.

The electron emission layer 20a, which primarily emits electrons, is made of at least one material selected from the group consisting of barium oxide, calcium oxide, strontium oxide, nickel, titanium, niobium, molybdenum, and their alloy.

The anti-collision layer 20b covers at least one portion of an outer surface of the electron emission layer 20a. In more detailed, the anti-collision layer 20b can partially or entirely cover the electron emission layer 20a and is made of an anti-collision material. In the present embodiment, the material of the anti-collision layer 20b is selected from the group consisting of ceramics, titanium, niobium, molybdenum, and their alloy. To be noted, the materials mentioned above are examples for illustrating, and it should be understood that other anti-collision material can be applied.

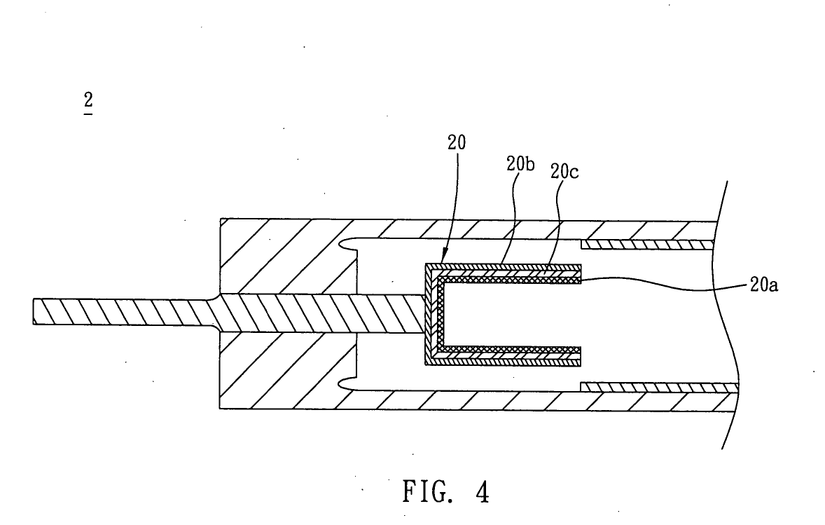

Additionally, with reference to FIG. 4, the electrode 20 can further includes an conduction layer 20c disposed between the electron emission layer 20a and the anti-collision layer 20b. Moreover, a work function value of the conduction layer 20c is larger than a work function value of the electron emission layer 20a. Thus, the manufacturing cost of the electrode with the same size as the conventional one is significantly reduced. In the present embodiment, the conduction layer 20c is made of nickel or its alloy.

In the present embodiment, the anti-collision layer 20b can be made of the material with a work function value smaller than that for composing the conduction layer 20c to achieve the desired anti-collision property. Accordingly, the work function value of the conduction layer 20c is larger than the electron emission layer 20a and the anti-collision layer 20b.

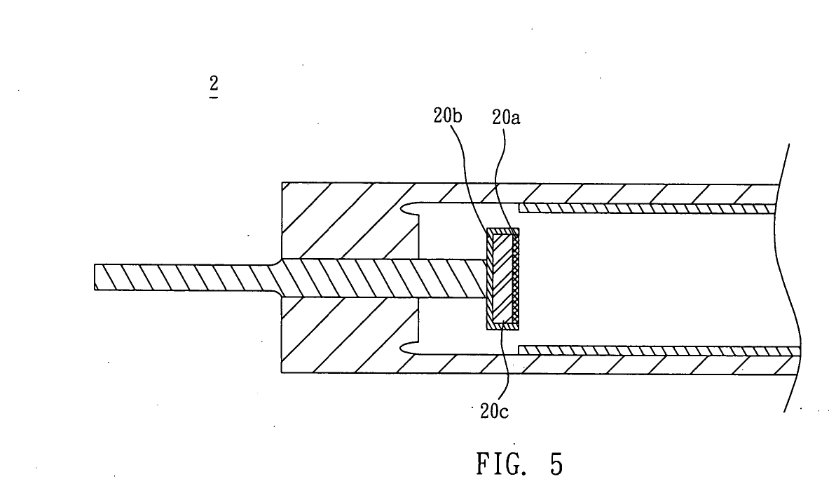

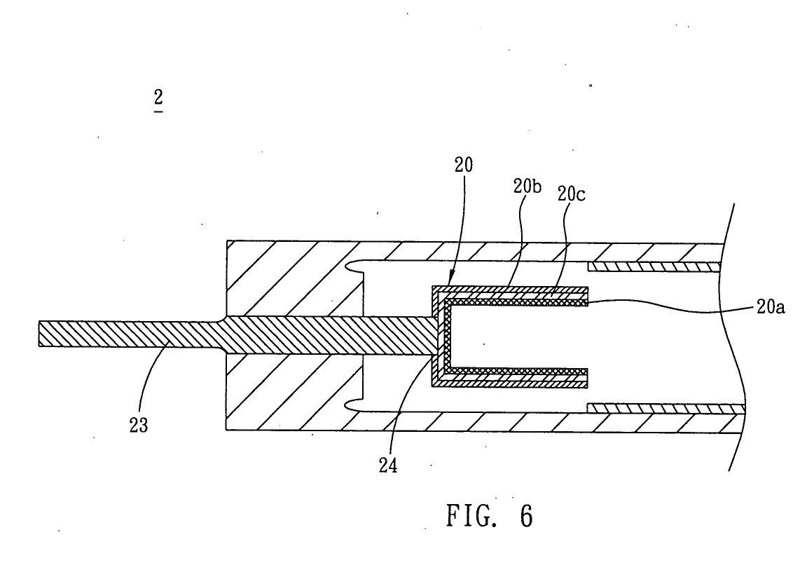

As mentioned above, the electrode 20 of the cold cathode fluorescent lamp 2 can be cylindrical (as shown in FIG. 3 and FIG. 4), U-shaped, V-shaped, Y-shaped, or plate-shaped (as shown in FIG. 5). It is practicable just based on the principle of disposing the electron emission layer 20a near the central of the cold cathode fluorescent lamp 2 and disposing the anti-collision layer 20b near a lead 23. In addition, with reference to FIG. 6, if the material of the anti-collision layer 20b is ceramics, which is not electric conductive, the lead 23 should be passed through a gap 24 of the anti-collision layer 20b for directly connecting to the conduction layer 20c or the electron emission layer 20a. According to the previous descriptions, those skilled people should be able to put it into practice.

Additionally, with reference to FIG. 3, a cold cathode fluorescent lamp 2 according to a preferred embodiment of the invention includes a housing 21 and at least one electrode 20. The inner surface of the housing 21 is coated with a florescent layer 102, and the rare gas and the mercury vapor are filled in the housing 21. The electrode 20 is set at one end of the housing 21. The electrode 20 includes an electron emission layer 20a and an anti-collision layer 20b. Herein, the structure, composition, and shapes of the electrodes 20 in this embodiment are the same as those of the previously mentioned electrodes, so the detailed descriptions are omitted for concise purpose.

As mentioned above, the electrode 20 is connected to a driving power supply through a lead 23. The driving power supply drives the electrode 20 to emit electrons, which sequentially react with the rare gas and the mercury vapor to generate ultraviolet rays. Thus, a visible light is then emitted when the ultraviolet rays excite the fluorescent layer 22 on the inner surface of the housing 21.

Since the anti-collision layer 20b of the electrode 20 covers at least one portion of the outer surface of the electron emission layer 20a and is made of an anti-collision material, the sputtered material of the electrode 20 can be reduced and the mercury vapor consumption can also be decreased.

In conclusion, a cold cathode fluorescent lamp and an electrode thereof according to the invention utilize an conduction layer, i.e. the anti-collision layer, to cover at least one portion of an outer surface of another conduction layer, i.e. the electron emission layer, which primarily emits electrons. In this case, the electron emission layer can be made of materials with a small work function value for reducing the threshold voltage. In addition, the anti-collision layer is made of an anti-collision material. Compared with the prior art, the cold cathode fluorescent lamp of the invention can significantly prevent the electrode from being sputtered and reduce the mercury vapor consumption. Thus, the lifetime of the cold cathode florescent lamp is increased. Moreover, since the electrode is partially composed of the conduction layer with the high work function value, the manufacturing cost of the electrode of the invention is less than that of the conventional electrode made of the conduction layer with low work function value only.

Although the invention has been described with reference to specific embodiments, this description is not meant to be construed in a limiting sense. Various modifications of the disclosed embodiments, as well as alternative embodiments, will be apparent to persons skilled in the art. It is, therefore, contemplated that the, appended claims will cover all modifications that fall within the true scope of the invention.

What is claimed is:

1. An electrode for a cold cathode fluorescent lamp, comprising:
an electron emission layer, and
an anti-collision layer covering at least one portion of an outer surface of the electron emission layer.

2. The electrode of claim 1, further comprising:
a conduction layer disposed between the electron emission layer and the anti-collision layer, wherein a work function value of the conduction layer is relatively larger than that of the electron emission layer.

3. The electrode of claim 2, wherein the conduction layer is made of nickel or alloy thereof.

4. The electrode of claim 2, wherein a work function value of the anti-collision layer is relatively smaller than that of the conduction layer.

5. The electrode of claim 1, wherein the electron emission layer is made of barium oxide, calcium oxide, strontium oxide, nickel, titanium, niobium, molybdenum, or alloy thereof.

6. The electrode of claim 1, wherein the anti-collision layer is made of ceramic, titanium, niobium, molybdenum, or alloy thereof.

7. The electrode of claim 6, wherein the anti-collision layer has a gap for allowing a lead to pass therethrough.

8. The electrode of claim 1, wherein the electrode is cylindrical, U-shaped, V-shaped, Y-shaped, or plate-shaped.

9. A cold cathode fluorescent lamp, comprising:
a housing; and
at least one electrode disposed at an end of the housing and comprising an electron emission layer and an anti-collision layer, wherein the anti-collision layer covers at least one portion of an outer surface of the electron emission layer.

10. The cold cathode fluorescent lamp of claim 9, wherein the electrode further comprises:
a conduction layer disposed between the electron emission layer and the anti-collision layer, wherein a work function value of the conduction layer is relatively larger than that of the electron emission layer.

11. The cold cathode fluorescent lamp of claim 10, wherein the conduction layer is made of nickel or alloy thereof.

12. The cold cathode fluorescent lamp of claim 10, wherein a work function value of the anti-collision layer is relatively smaller than that of the conduction layer.

13. The cold cathode fluorescent lamp of claim 9, wherein the material of the conduction layer is barium oxide, calcium oxide, strontium oxide, nickel, titanium, niobium, molybdenum, or alloy thereof.

14. The cold cathode fluorescent lamp of claim 9, wherein the material of the anti-collision layer is ceramic, titanium, niobium, molybdenum, or alloy thereof

15. The cold cathode fluorescent lamp of claim 14, wherein the anti-collision layer has a gap for allowing a lead to pass therethrough.

16. The cold cathode fluorescent lamp of claim 9, wherein the electrode is cylindrical, U-shaped, V-shaped, Y-shaped, or plate-shaped.
